(19) United States
(12) Patent Application Publication
(10) Pub. No.: US 2010/0210121 A1
(43) Pub. Date: Aug. 19, 2010

(54) CONNECTOR AND ELECTRONIC DEVICE HAVING THE SAME

(75) Inventor: Jane-How Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/701,595

(22) Filed: Feb. 7, 2010

(30) Foreign Application Priority Data
Feb. 18, 2009 (TW) 98105181

(51) Int. Cl. H01R 12/00

(52) U.S. Cl. 439/78

(57) ABSTRACT

A connector and an electronic device having the same are disclosed. The connector includes a base disposed on a circuit board, a surrounding side wall, multiple connection terminals, a covering member and a resilient structure. The surrounding side wall is formed surrounding the base and defining a slot. The connection terminals pass through and secured with the base, respectively and may be electrically connected to the circuit board. The covering member is disposed at the top of the slot and has multiple through holes corresponding to the connection terminals, respectively. The resilient structure supports the covering member to be located at the top of the slot. When an external force applies on the covering member and deforms the resilient structure, the connection terminals respectively pass through the through holes of the covering member and are therefore revealed for connecting and communicating with the wire connector to transmit signal.

### CROSS-REFERENCE TO RELATED APPLICATION

This application claims the priority benefit of Taiwan application serial no. 98105181, filed on Feb. 18, 2009. The entirety of the above-mentioned patent application is hereby incorporated by reference herein and made a part of specification.

### BACKGROUND OF THE INVENTION

1. Field of the Invention

The invention relates to a connector and an electronic device and, more particularly, to a connector having a covering member and an electronic device having the same.

2. Description of the Related Art

With the progress of the IT technology, computers have become widely used device by people for application processing, web browsing, multimedia playing or data storing. With the development, computer therefore becomes necessary tools in modern people's daily life.

Computers, no matter laptops or notebooks, have circuit boards and various electronic components disposed on the circuit board and perform different functions. said electronic components such as connectors, are provided to connect with peripheral equipments like keyboards, mouses, universal serial bus (USB) disks and so on. In practice, the connectors are electrically connected with the circuit board via transmitting lines, such that a connection between the peripheral equipment and the circuit board may achieve via the connector. For the detail, the connector generally includes a slot and multiple terminals disposed in the slot. The connection terminal is electrically connected to the circuit board.

To prevent dust from accumulating in the connector, even more prevent the connector from being damaged by external force, lids are sometimes designed with the connectors for covering the slot. in such manner, when the connector is used, the lid have to be removed or detached from the connector. Besides, for further identification purpose, identifying symbols are formed at the circuit board around the connector. However, users may feel inconvenient to remove or cap the lid everytime the connector is used. Furthermore, due to dim ambient light or visual obstacle from other components, identifying symbols located at the circuit board around the connector may be too difficult to perform for the users.

### BRIEF SUMMARY OF THE INVENTION

The invention provides a connector which exposes terminals without removing the covering member when the connector is used.

The invention provides an electronic device having a connector that exposes terminals from a covering member without removing the covering member when the connector is used.

The invention provides a connector including a base, a surrounding side wall, multiple connection terminals, a covering member and a resilient structure. The surrounding side wall is formed surrounding the base, and thereby defines a slot therebetween. The connection terminals pass through and secured with the base, and one end of each of the connection terminals is disposed in the slot. The covering member is disposed in the slot and has multiple through holes corresponding to the connection terminals, respectively. The resilient structure is mounted between the covering member and the base to support the covering member at a top of the slot. When an external force applies on the covering member and deforms the resilient structure, the connection terminals respectively pass through the through holes of the covering member and are therefore revealed in the slot.

The invention discloses an electronic device including a circuit board, multiple electronic components and at least a connector. The electronic component is disposed on the circuit board. The connector includes a base, a surrounding side wall, multiple connection terminals, a covering member, and a resilient structure. The base is disposed on the circuit board. The surrounding side wall is formed surrounding the base, and thereby defines a slot therebetween. The connection terminals pass through and secured with the base, one end of each of the connection terminals is disposed in the slot, and an another end is electrically connected to the circuit board. The covering member is disposed in the slot and has multiple through holes corresponding to multiple connection terminals, respectively. The resilient structure is mounted between the covering member and the base for supporting the covering member at a top of the slot. When an external force applies on the covering member and deforms the resilient structure, the connection terminals respectively pass through the through holes of the covering member and are therefore revealed for electrical connection.

In an embodiment of the invention, the covering member has an identifying symbol at a surface.

In an embodiment of the invention, the identifying symbol is a character or a pattern.

In an embodiment of the invention, the identifying symbol includes a first part and a second part that having different colors.

In an embodiment of the invention, the identifying symbol is a protruding pattern or a recessed pattern.

In an embodiment of the invention, the identifying symbol is a sticker.

In an embodiment of the invention, the identifying symbol includes two resilient elements mounted at two corresponding sides of the base and abutting against the covering member, respectively.

In an embodiment of the invention, the connector further includes multiple dividing walls extending from the surrounding side wall and forming two recesses for containing the resilient elements, respectively.

In an embodiment of the invention, each resilient element is a spring or a resilient plate.

In an embodiment of the invention, the surrounding side wall has at least a guiding slot, and the covering member has at least a guiding element slidably engaged with the guiding slot.

Based on the above, in the connector of the electronic device in the invention, a resilient structure is mounted between the covering member and the base for supporting the covering member at a top of the slot. When the user wants to use the connector, he or she does not need to remove the covering member. Instead, the user may directly plug a wire connector into the slot to press the covering member down toward the base, such that the connection terminals may pass through the through holes of the covering member and electrically connected to the wire connector.

Aforementioned features, aspects and advantages of the present invention will become better understood with regard to the following description, appended claims, and accompanying drawings.

### BRIEF DESCRIPTION OF THE DRAWINGS

FIG. 1 is a three-dimensional schematic diagram showing an electronic device in an embodiment in accordance with the invention;

FIG. 2 is three-dimensional schematic diagram showing the connector in FIG. 1;

FIG. 3 is a sectional diagram showing partial structure of the connector in FIG. 1;

FIG. 4 is a sectional diagram showing partial structure of the connector with an external force applying in FIG. 3;

FIG. 5 and FIG. 6 are sectional diagrams showing partial structure of the connector in FIG. 3 and FIG. 4;

FIG. 7 is a top view diagram showing the covering member in FIG. 1;

FIG. 8 is a top view diagram showing the covering member in another embodiment of the invention;

FIG. 9 is a top view diagram showing the covering member in still another embodiment of the invention;

FIG. 10 is a side view diagram showing the covering member in FIG. 7;

FIG. 11 is a side view diagram showing the covering member in still another embodiment in accordance with the invention;

FIG. 12 is a sectional diagram showing partial structure of the connector in still another embodiment of the invention.

### DETAILED DESCRIPTION OF THE EMBODIMENTS

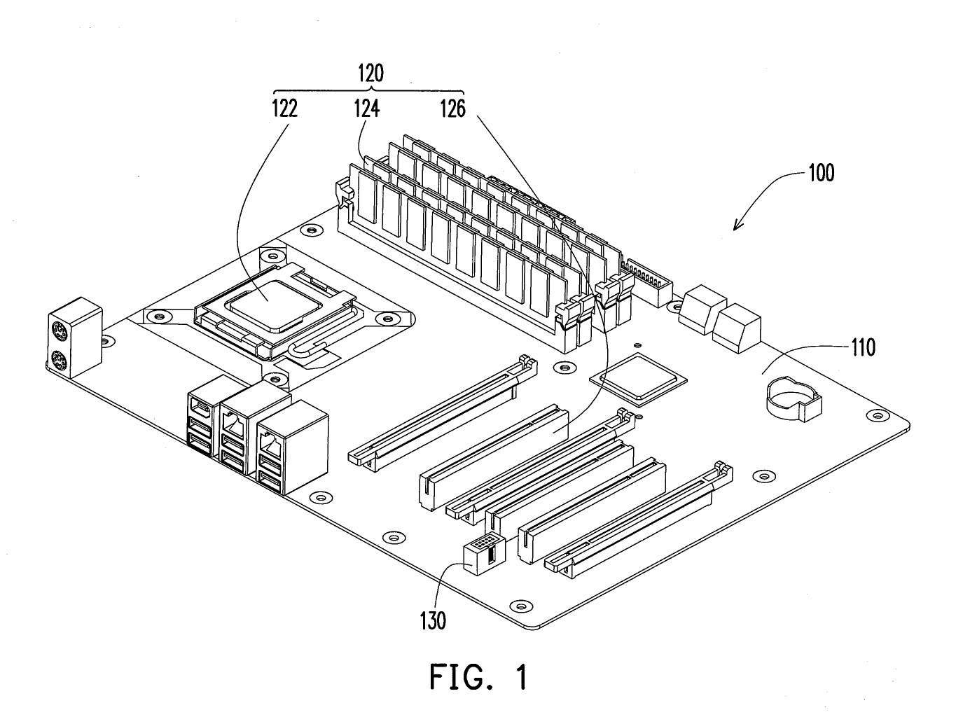

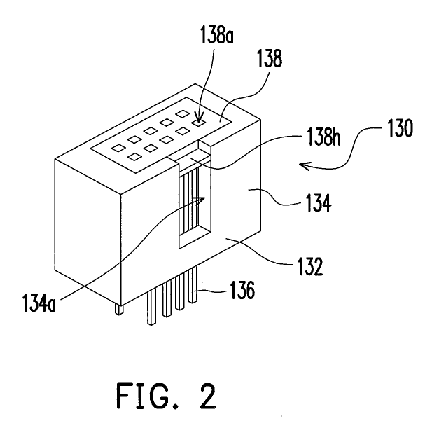

FIG. 1 is a three-dimensional schematic diagram showing an electronic device in an embodiment of the invention. FIG. 2 is three-dimensional diagram showing the connector in FIG. 1. As shown in FIG. 1 and FIG. 2, the electronic device 100 in the embodiment includes a circuit board 110, multiple electronic components 120 and a connector 130. The electronic components 120 are disposed on the circuit board 110 and include a central processing unit (CPU) 122, a memory 124, an interface card slot 126 and other components. The connector 130 includes a base 132, a surrounding side wall 134, multiple connection terminals 136 and a covering member 138.

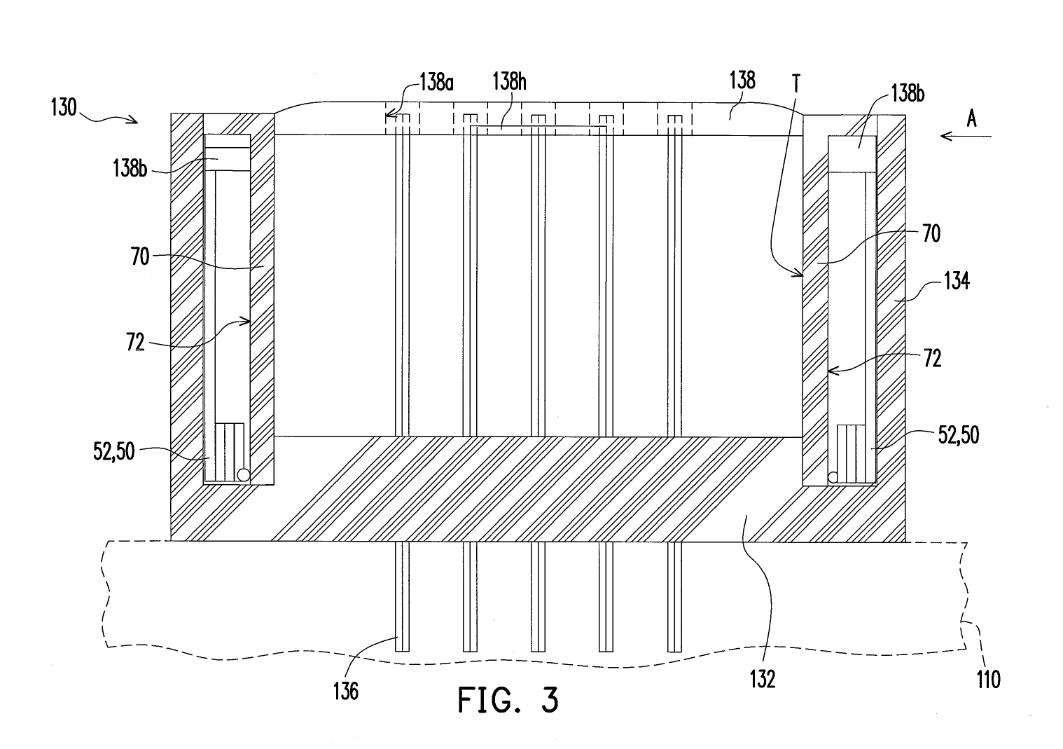

FIG. 3 is a sectional diagram showing partial structure of the connector in FIG. 1. As shown in FIG. 2 and FIG. 3, the base 132 is disposed on the circuit board 110. The surrounding side wall 134 is formed surrounding the base 132, and thereby defines a slot T between the base 132 and the surrounding side wall 134. The connection terminals 136 pass through and secured with the base 132, respectively, and one end of each of the connection terminals 136 is disposed in the slot T and an another end electrically connected to the circuit board 110. The covering member 138 is disposed in the slot T and has multiple through holes 138a corresponding to the connection terminals 136. The connector 130 further includes a resilient structure 50 mounted between the covering member 138 and the base 132. The resilient structure 50 supports the covering member 138 to make the covering member 138 located at the top of the slot T.

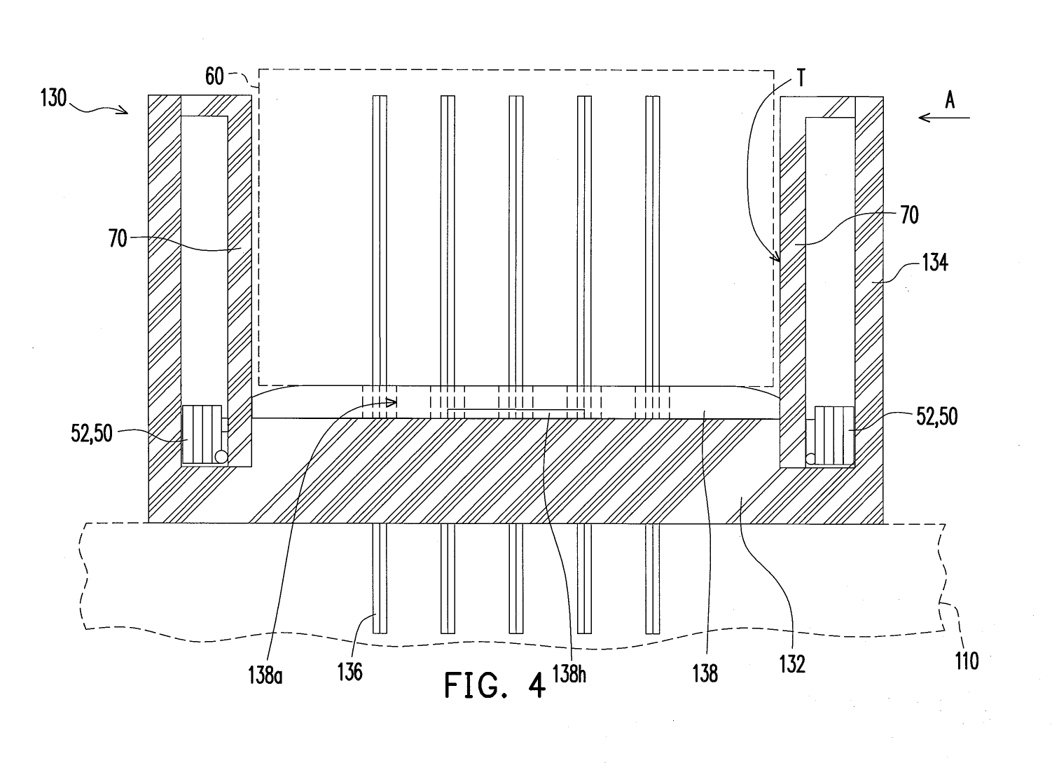

FIG. 4 is a sectional diagram showing partial structure of the connector with an exerted force applying in FIG. 3. As shown in FIG. 4, when the user presses a wire connector 60 onto the covering member 138, the resilient structure 50 may be deformed to allow the covering member 13 move toward the base 132, such that the connection terminals 136 may pass through the through holes 138a of the covering member 138 to connect the wire connector 60 and make the wire connector 60 electrically connected to the circuit board 110. In other words, during the process of connection, the covering member 138 does not need to be removed, but automatically moved downward.

As shown in FIG. 3, in the embodiment, the resilient structure 50 includes two resilient elements 52 respectively mounted at two corresponding sides of the base 132 and abutting against the covering member 138. The connector 130 further includes multiple dividing walls 70 extending from the surrounding side wall 134 and forming two recesses 72 to contain the resilient elements 52 and two covering member side parts 138b of the covering member. In the embodiment, each resilient element 52 is, for example, a resilient plate.

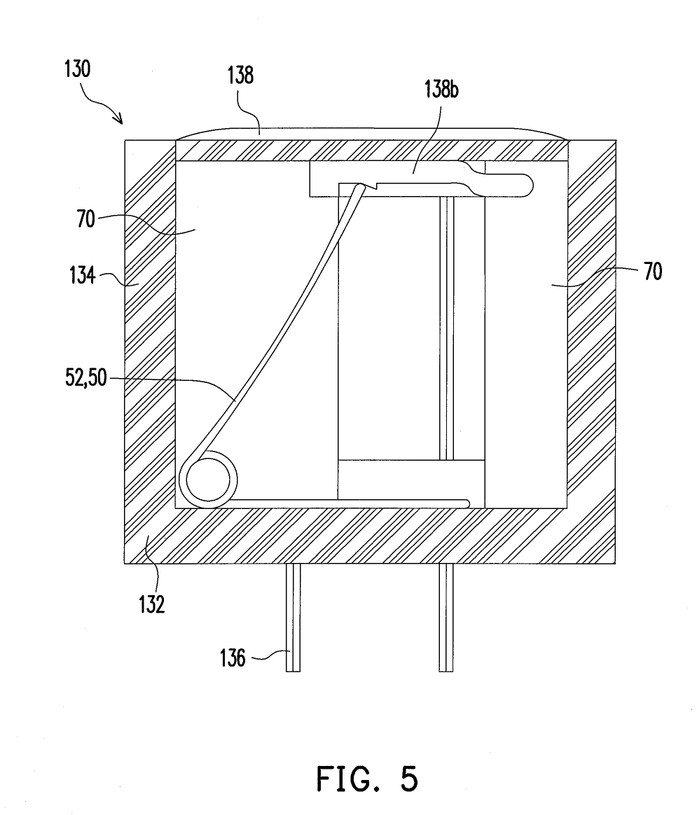

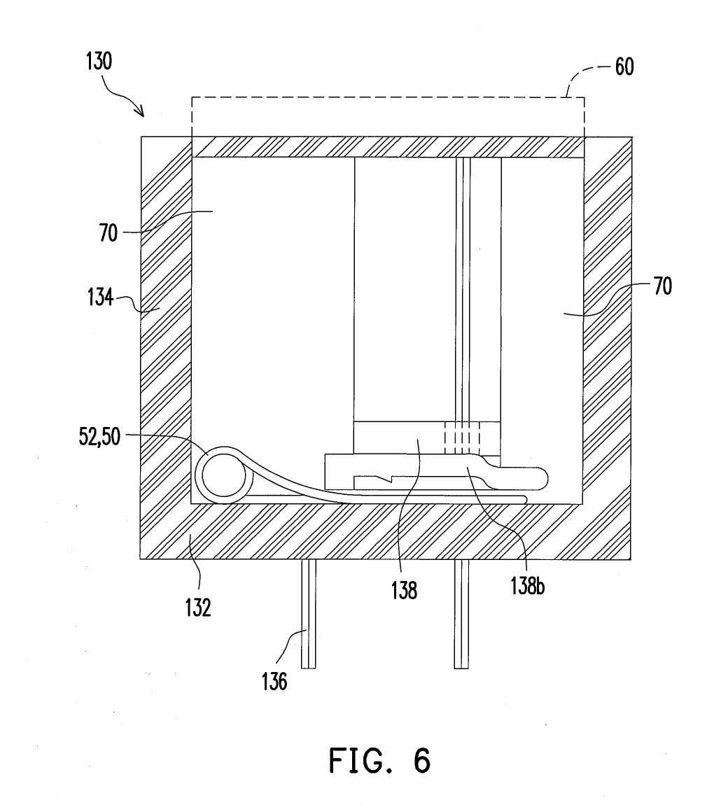

FIG. 5 and FIG. 6 are sectional diagrams showing partial structure of the connector in FIG. 3 and FIG. 4. As shown in FIG. 5, when no force applies on the resilient structure 50, the covering member 138 is supported by the resilient elements 52 and located at the top of the slot T. As shown in FIG. 6, when a user presses a wire connector 60 onto the covering member 138, an external force applying on the covering member 138 will deform the resilient structure 50, then the connection terminals 136 may respectively pass through the through holes 138a of the covering member 138 and are therefore revealed in the slot T.

In addition, as shown in FIG. 2, in the embodiment, the surrounding side wall 134 has a guiding slot 134a, and the covering member 138 has a guiding element 138h slidably engaged with the guiding slot 134a. The embedding relationship between the guiding slot 134a and the guiding element 138h makes the covering member 138 disposed in the slot T more firmly and improves the stableness when the covering member 138 is moving.

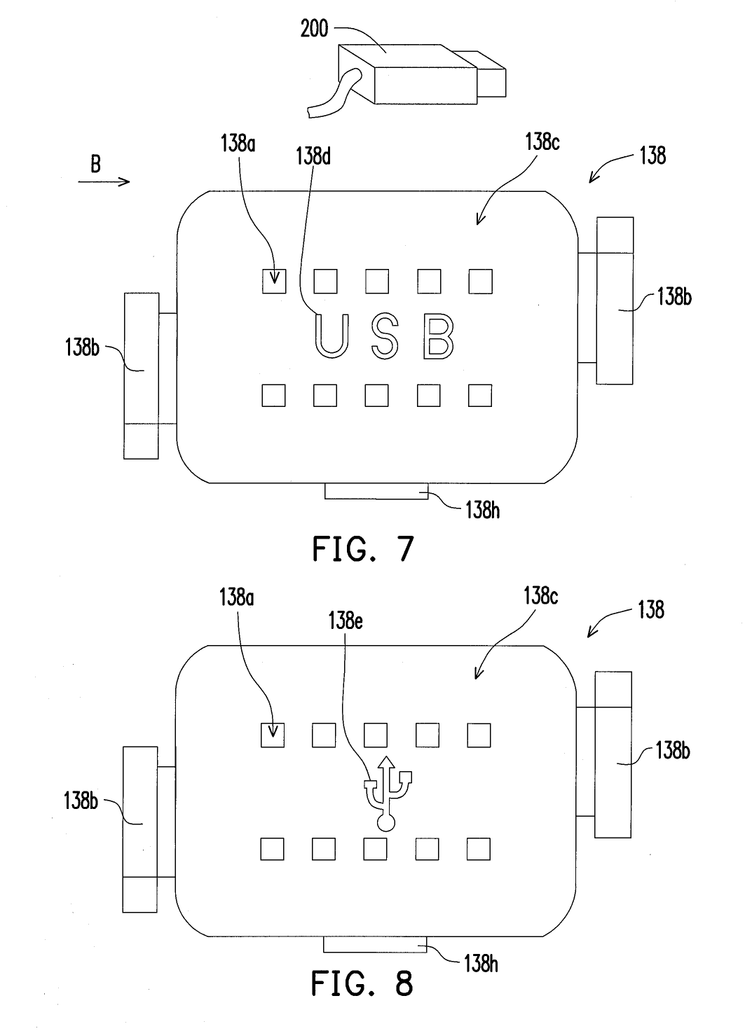

FIG. 7 is a top view diagram showing the covering member in FIG. 1. As shown in FIG. 7, the covering member 138 has an identifying symbol 138d at a surface 138c to allow the user to identify the function of the connector 130. In the embodiment, the identifying symbol 1138d may be character denoting that the connector 130 in FIG. 1 is adapted to a wire connector 200. The wire connector 200 may be a universal serial bus (USB) connector.

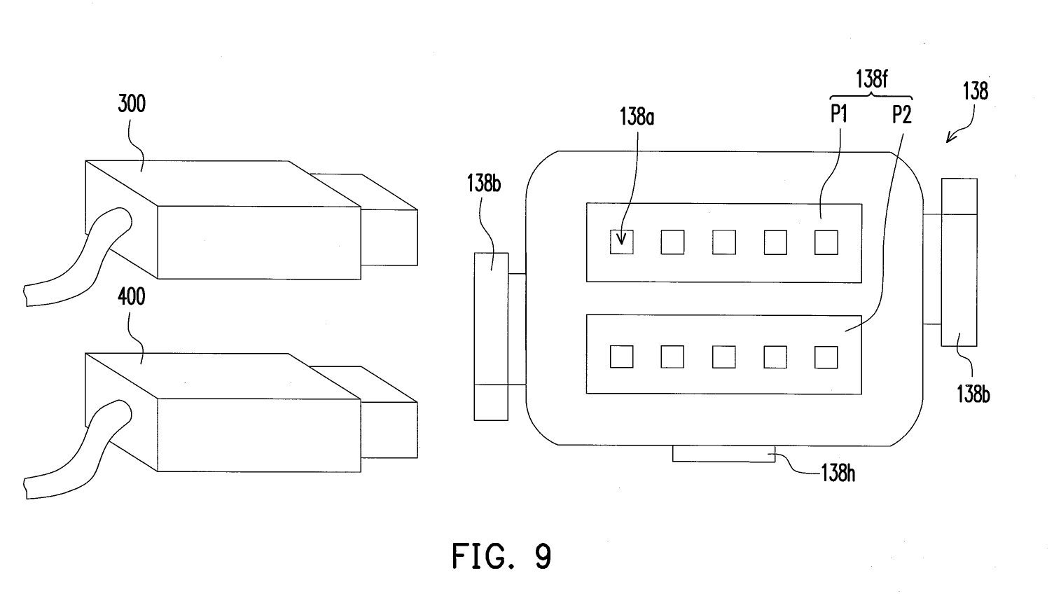

FIG. 8 is a top view diagram showing the covering member in another embodiment of the invention. As shown in FIG. 8, in the embodiment, the identifying symbol 138e of the covering member 138 also may be a pattern and has the same function as the identifying symbol 138d in FIG. 7. FIG. 9 is a top view diagram showing the covering member in still another embodiment of the invention. As shown in FIG. 9, in the embodiment, the identifying symbol 138f of the covering member 138 includes a first part P1 and a second part P2 having different colors to denote that the connection terminals corresponding to the first part P1 and the connection terminals (not shown) corresponding to the second part P2 are adapted to the first wire connector 300 and the second wire connector 400, respectively. In other words, the connector in the invention may be connected to a single wire connector (as shown in FIG. 7) or multiple wire connectors (as shown in FIG. 9), and the denoting mode of the identifying symbol on the covering member may be adjusted correspondingly.

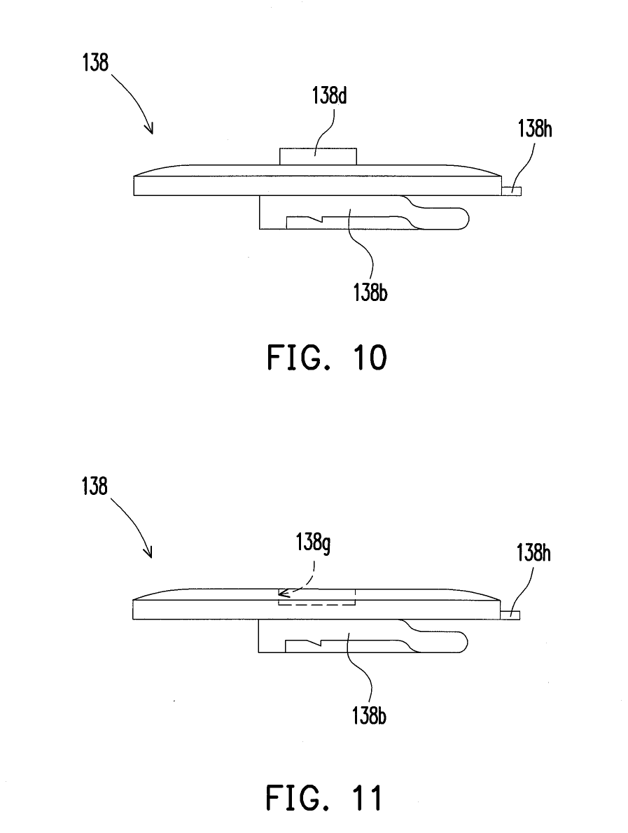

FIG. 10 is a side view diagram showing the covering member in FIG. 7. As shown in FIG. 10, the identifying symbol 138d may be a protruding symbol. FIG. 11 is a side view diagram showing the covering member in still another embodiment of the invention. As shown in FIG. 11, compared with FIG. 10 in which the identifying symbol 138d is a protruding symbol, the identifying symbol 138g herein also may be a recessed symbol. In addition, as shown in FIG. 9, the identifying symbol 138f also may be a sticker, and the first part P1 and the second part P2 may be two stickers having different colors.

The identifying symbol in the above embodiment is defined on the covering member and corresponds to the connection terminals, which may allow the user to identify the purpose of the connector directly and conveniently. In addition, the types of the identifying symbols may be different, and FIG. 7 to FIG. 11 shows some types taken as examples. In addition, a skilled person in the art may make the types matched with each other to develop new types, such as a character sticker, an image sticker, a protruding pattern or a recessed pattern.

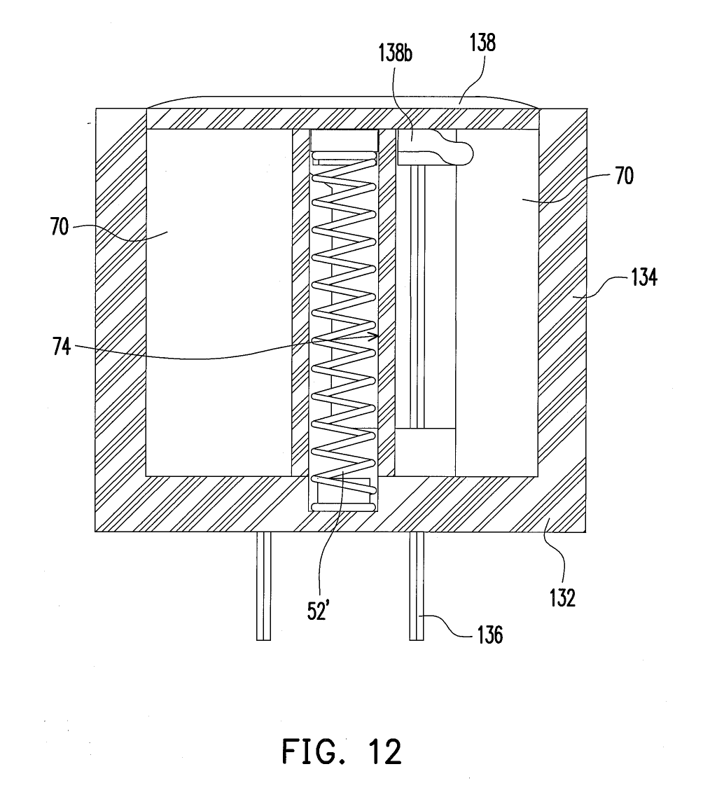

FIG. 12 is a sectional diagram showing partial structure of the connector in still another embodiment of the invention. As shown in FIG. 12, the resilient element 52′ in the embodiment is a spring and may be deformed and generate a resilient force, which is similar with the resilient plate in FIG. 5 (resilient element 52). The spring also may be deformed and provide a support. In the invention, the types of the resilient structure and the resilient element are not limited, may be a resilient plate, a spring or other proper resilient objects. In addition, in the embodiment, the dividing wall 70 further has multiple resilient element guiding slots 74 extending from the dividing wall 70 to limit the displacement of the resilient element 52′.

To sum up, in the electronic device of the invention, a resilient structure is mounted between the covering member of the connector and the base, and the resilient structure supports the covering member to make the covering member located at the top of the slot. When the user wants to use the connector, he or she does not need to remove the covering member, but only press the covering member by a wire connector to make the covering member move toward the base and let the connection terminals pass through the through holes of the covering member, then electrical connection between the circuit board and the wire connector may be achieved. In addition, the identifying symbol on the covering member allows the user to identify the function of the connector directly and conveniently.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A connector comprising:
a base;
a surrounding side wall formed surrounding the base and defining a slot;
multiple connection terminals passing through and secured with the base, wherein one end of each of the connection terminals is disposed in the slot;
a covering member disposed in the slot and having multiple through holes corresponding to the connection terminals, respectively; and
a resilient structure mounted between the covering member and the base for supporting the covering member at a top of the slot;
wherein when an external force applies on the covering member and deforms the resilient structure, the connection terminals respectively pass through the through holes of the covering member and are therefore revealed in the slot.

2. The connector according to claim 1, wherein the surrounding side wall has at least at least a guiding slot, and the covering member has at least a guiding element slidably engaged with the guiding slot.

3. The connector according to claim 1, wherein the resilient structure comprises two resilient elements mounted at two corresponding sides of the base, respectively, and abutting against the covering member.

4. The connector according to claim 3, further comprising multiple dividing walls extending from the surrounding side wall and forming two recesses, wherein the recesses contain the resilient elements, respectively.

5. The connector according to claim 3, wherein each of the resilient elements is a spring or a resilient plate.

6. The connector according to claim 1, wherein the covering member has an identifying symbol formed at a surface.

7. The connector according to claim 6, wherein the identifying symbol is a character or a pattern.

8. The connector according to claim 6, wherein the identifying symbol comprises a first part and a second part having different colors.

9. The connector according to claim 6, wherein the identifying symbol is a protruding symbol or a recessed symbol.

10. The connector according to claim 6, wherein the identifying symbol is a sticker.

11. An electronic device, comprising:
a circuit board;
multiple electronic components disposed on the circuit board; and
at least a connector including:
a base disposed on the circuit board;
a surrounding side wall formed surrounding the base and defines a slot;
multiple connection terminals passing through and secured with the base, wherein one end of each of the connection terminals is disposed in the slot, and an another end is electrically connected to the circuit board;
a covering member disposed in the slot and having multiple through holes corresponding to the connection terminals, respectively; and
a resilient structure mounted between the covering member and the base for supporting the covering member at a top of the slot;
wherein when an external force applies on the covering member and deforms the resilient structure, the connection terminals respectively pass through the through holes of the covering member and are therefore revealed in the slot.

12. The electronic device according to claim 11, wherein the surrounding side wall has at least a guiding slot, and the covering member has at least a guiding element slidably engaged with the guiding slot.

13. The electronic device according to claim 11, wherein the resilient structure comprises two resilient elements mounted at two corresponding sides of the base, respectively, and abutting against the base.

14. The electronic device according to claim 13, further comprising multiple dividing walls extending from the surrounding side wall and forming two recesses, wherein the recesses contain the resilient elements.

15. The electronic device according to claim 13, wherein each of the resilient elements is a spring or a resilient plate.

16. The electronic device according to claim 11, wherein the covering member has an identifying symbol at a surface.

17. The electronic device according to claim 16, wherein the identifying symbol is a character or a pattern.

18. The electronic device according to claim 16, wherein the identifying symbol comprises a first part and a second part having different colors.

19. The electronic device according to claim 16, wherein the identifying symbol is a protruding symbol or a recessed symbol.

20. The electronic device according to claim 16, wherein the identifying symbol is a sticker.
